(19) United States
(12) Patent Application Publication
(10) Pub. No.: US 2009/0100018 A1
(43) Pub. Date: Apr. 16, 2009

(54) SYSTEM AND METHOD FOR CAPTURING, INTEGRATING, DISCOVERING, AND USING GEO-TEMPORAL DATA

(76) Inventor: Jonathan Roberts, Seattle, WA (US)

Correspondence Address: SCHWEGMAN, LUNDBERG & WOESSNER, P.A., P.O. BOX 2938, MINNEAPOLIS, MN, 55402, US

(21) Appl. No.: 11/871,842

(22) Filed: Oct. 12, 2007

(51) Int. Cl. G06F 17/30; G06F 3/048

(52) U.S. Cl. 707/3; 715/764; 707/E17.014

(57) ABSTRACT

Various embodiments relate to the systems and methods for creating events, creating points of interest, associating points of interest with geographic locations, associating events with points of interest or with geographic locations, discovering events in a geographic area given a time frame, tagging and rating events and points of interest and sharing events among users. A particular embodiment includes a computer-implemented method including associating geographical locations or points of interest with events having geographical and temporal attributes in a geo-temporal data store, receiving a geo-temporal search query specified by a user, and producing search results including items from the geo-temporal data store having a pre-determined degree of relevance to the geo-temporal search query in both a geographical and temporal domain.

### BACKGROUND

### Copyright

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006-2007, Jonathan Roberts, All Rights Reserved.

1. Technical Field

The various embodiments described herein relate to the fields of geographic search and calendar management. More specifically, the various embodiments relate to the techniques for creating events, creating points of interest, associating points of interest with geographic locations, associating events with points of interest or with geographic locations, discovering events in a geographic area given a time frame, tagging and rating events and points of interest and sharing events among users.

2. Related Art

In the field of electronic geographic mapping, it is common to provide a means to search for a location. For example, Google maps allow the user to search for “1410 30th Ave Seattle, Wash.” as a specific Address or simply “Seattle, Wash.” as a broader geographic location. Further, the user can search for “Safeway Seattle, Wash.” as a POI within a geographic location.

In the field of calendaring, each calendar is owned by a user. The owner can create events in the calendar, can invite other users to the event and can even associate the name of a location with that event. One problem people face is discovering events by type, location and timeframe. For example, one might be interested in finding “Jazz in Seattle, Wash. next Saturday evening”. There is currently no means of doing so better than using a mapping search engine. The results given by a mapping search engine yield markers on maps associated with links to web pages which lack any common semantic form expressing either geographic or temporal information. This semantic poverty limits the utility of the results—the user is left to find events manually.

There is currently no holistic integration of geo-temporal data. That is, there is no means for associating calendars with Points of Interest (POIs) or even referencing POIs or addresses with user-owned events. The various embodiments described herein address this integration.

### SUMMARY

The embodiments described herein provide various features to help users search for geo-temporal data; specifically but not limited to calendar events associated with POIs or locations.

A calendar can be a collection of events associated with either a user or with a Point of Interest (POI). An event can be an activity suitable for calendaring with the following attributes: start time, duration/end time, and location. Geo-temporal data includes data having both geographic and temporal characteristics. For example, “1410 30th Ave Seattle, Wash. 98122-3212 7 pm Tuesday Sep. 18, 2007” is a geo-temporal datum. A POI can stand in for a location as in “Jonathan's House 7 pm Tuesday Sep. 18, 2007”. A Geo-calendar view can be a view of a user's calendar which includes a map with markers indicating the locations of events on the same calendar. A location can be a specific place or region specified by an address, coordinates (as in latitude, longitude) or some other means. An address may be partial as in Topeka, Kans. or may be complete as in 1410 30th Ave Seattle, Wash. USA 98122-3212. A Point of Interest (POI) can be an aggregate datum containing at least a name, and a location. A rating is a scalar associated with an event or with a POI. Ratings, which can be supplied by users, are aggregated by the system and are presented to end users who may be interested in the opinions of others. An example rating is 3.8 out of 5. This would indicate moderate popular confidence in the merits of the thing being rated. An event or a POI can have tags associated with it. Tags are generally submitted by the user and are useful for discovering events or POI when used as search terms.

The various embodiments enable users to associate temporal data with geographic locations or POIs. It allows the user to create a POI for a location, create a calendar for a POI or location, add events to that calendar, tag POIs, tag events, rate POIs and rate events. This association between POIs (or locations), events and tags ultimately leads to an ability to discover events using geographic, temporal and other search cues (tags).

The various embodiments enable the user to add a POI's event or a location's event to his/her own calendar, reference his/her calendar in a geo-temporal view and share geo-temporal events with other users.

The various embodiment provide a means of automatically associating web-based documents with times and places making these documents searchable not only by content, but also by geographic and temporal cues.

The various embodiments provide a means to compile geo-temporal data and tag data into geographic and temporal data segments optimized to take advantage of predicted usage patterns. Compiling is necessary to enable scaling as the density of geo-temporal data grows and evolves both in the geographic dimension and in the temporal dimension.

The various embodiments include a search scheduler to organize the work necessary to execute the search. The actual searches are performed by the various services.

The various embodiments introduce a POI search relevance service and a geo-temporal search service.

The various embodiments enable the user to share events with other users.

The various embodiments enable new means of narrow-cast advertising based on geo-temporal constraints.

### BRIEF DESCRIPTION OF THE FIGURES

These and other features and advantages of the various embodiments will now be described with reference to the drawings of certain preferred embodiments intended to illustrate and not to limit the claimed invention, and in which:

FIG. 1 illustrates the overall architecture of a particular embodiment. The example architecture includes users, applications, a search scheduler, search services, data stores (raw and compiled) and data compilers.

FIG. 2 illustrates search results for events in a location and at a particular time.

FIG. 3 illustrates how a search request is processed by the system and results displayed to the user.

FIG. 4 illustrates a view of a user's events calendar for a specific day with geographic markers to complement the day's events and recommended events. This is termed the geo-calendar view.

FIG. 5 illustrates how the system determines what recommendations to give the user who is consulting his/her calendar.

FIG. 6 illustrates the rating and tagging of an event in the search results view or geo-calendar view.

FIG. 7 illustrates a POI's calendar.

FIG. 8 illustrates a user's calendar.

FIG. 9 illustrates searching for an as-yet un-calendared POI.

FIG. 10 illustrates processing geo-temporal data automatically from web-crawled content.

FIG. 11 illustrates adding an event to an address or a POI.

FIG. 12 illustrates adding a POI to the map.

FIG. 13 illustrates tagging an event.

FIG. 14 illustrates tagging a POI.

FIG. 15 illustrates adding an event to a POI's calendar.

FIG. 16 illustrates searching for a location with no associated POI or calendar.

FIG. 17 illustrates adding a POI to a location.

FIG. 18 illustrates a mini-calendar for navigating through time.

FIG. 19 shows a diagrammatic representation of a machine in the form of a computer system within which a set of instructions, for causing the machine to perform any one or more of the methodologies discussed herein, may be executed, according to an example embodiment.

### DETAILED DESCRIPTION

One feature of the various embodiments involves discovering and displaying events in response to a user's query via some application—events of a specific type during a specific time frame given a geographic location. Another feature involves users creating and editing POIs, creating and editing calendars for POIs, creating and editing calendars for locations, creating and editing events on calendars associated with POIs or locations, creating and editing events on their own calendars and sharing events with other users. Another feature involves users tagging and rating POIs and events and data compilers making these tags available for future searches. Another feature involves the user adding an event already associated with a POI or location to his/her own calendar. Another feature involves the user reviewing his/her own calendar in a geo-temporal mode so s/he can see not only his/her upcoming appointments, but also where those appointments are located on a map. Another feature involves automatically associating web-based documents with times and places. Another feature involves compiling geo-temporal data and tag data into forms best suited for searching given queries with geographic, temporal and tag information. Another feature involves the use of a search scheduler which organizes search queries among various search services including but not limited to search services optimized for tagged events, tagged POIs, time-based queries and geographic queries. Another feature involves the use of search services optimized for finding tagged events, tagged POIs, time-based queries and geographic queries. Another feature involves narrow-cast advertising to the customer based, in part, on geo-temporal constraints. In the preferred embodiment, these features are embodied with common applications, services and data stores; as will be apparent, these and other features of the various embodiments can be used independently of one another and may therefore be considered as distinct embodiments. For convenience of description, however, the term “various embodiments” is used herein to refer collectively to the various inventive features enclosed.

A preferred embodiment and implementation of the various embodiments will now be described with reference to the drawings. The description will reference various details of the various embodiments in the context of commonly available internet applications for searching, maps and calendars. The details are set forth in order to illustrate, and not to limit the various embodiments. The scope of the various embodiments is defined only by the appended claims.

### A. Overview of the Applications and Services of a Particular Embodiment

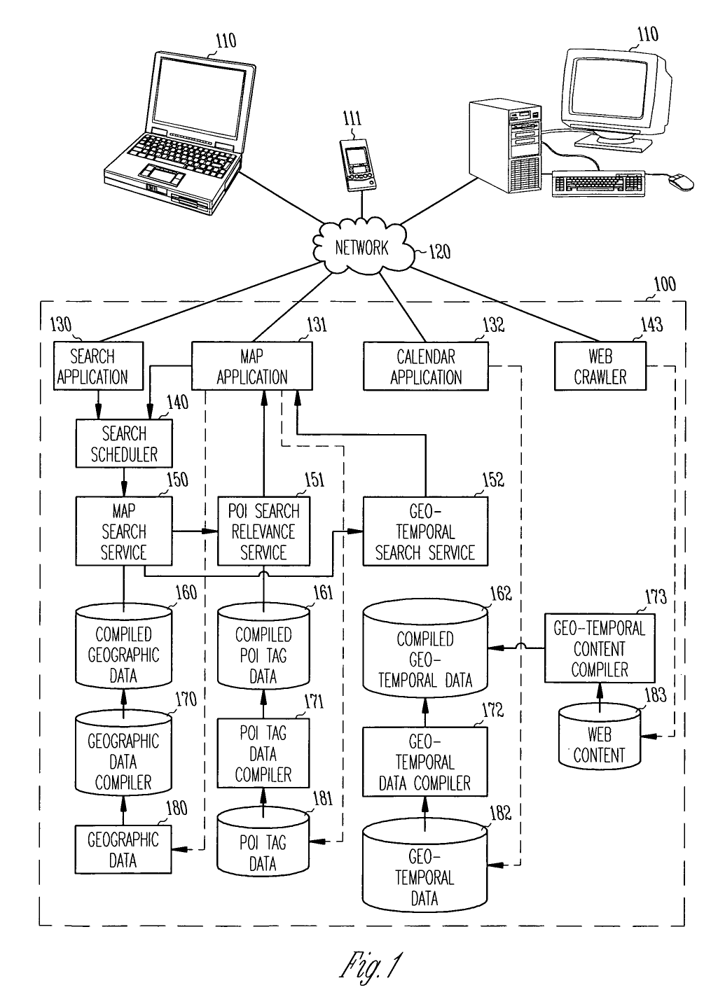

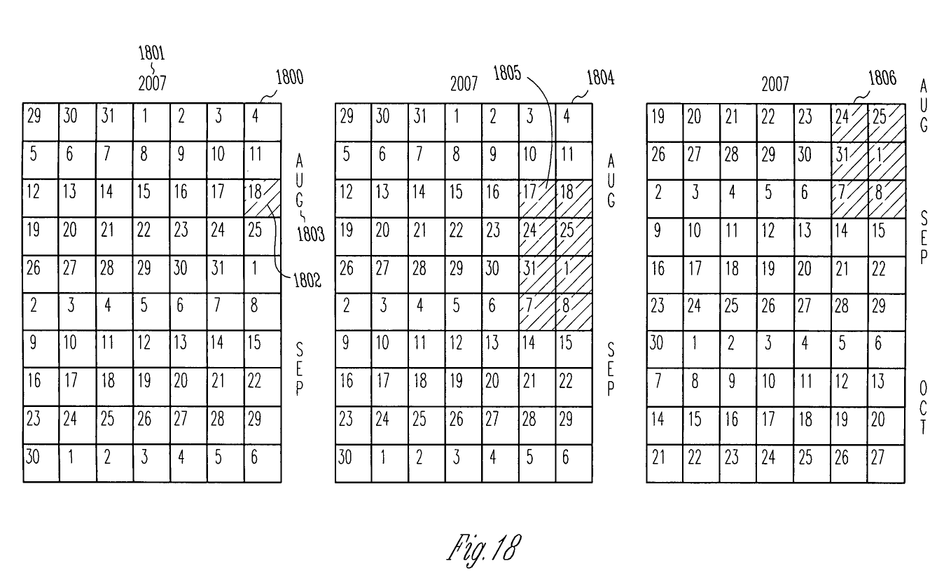

FIG. 1 illustrates a website 100, including components used to implement a geo-temporal search engine and calendar in accordance with the various embodiments. As is well known in the art of Internet geographic search, a typical map includes functionality allowing users to search for an address (full or partial address), search for a POI, pan, zoom and get information about flagged locations (addresses or POIs). The various embodiments described herein extend this functionality to include a temporal dimension to both search and browse. Temporal browse is the time-based analogue to geographic pan and zoom. Temporal browsing is illustrated in FIG. 18.

As shown in FIG. 1, the website 100 includes a search application 130 which handles all searches (geo-temporal and otherwise) and processes user requests from user computers 110 and mobile devices 111 (including but not limited to phones, mobile devices and automobiles) via the Internet 120. These queries may be submitted by users or submitted by non-human intermediate applications. A geographic query includes terms which indicate a geographic location. A geo-temporal query includes both geographic location and temporal information.

The website also includes a search scheduler which plans the search to be executed by numerous services including but not limited to the map search service 150 the POI search relevance service 151 and the temporal search service 152. These services depend on data which has been deployed in such a way as to enable scaling. The deployment profile creates the scalability and is determined by a series of data compilation services, one for each compiled data store.

Geographic data 180 includes addresses, POIs, location coordinates, etc. supplied by an external data source such as Navteq®. Geographic data 180 also includes POIs supplied by map application 131 users 110, 111. For instance, a new restaurant not yet captured by Navteq® but located at an existing address could be added by a user. Additionally, “the fence” at Carnegie Mellon University will likely never be added to Navteq®, but a particular embodiment allows users to add it anyway. A geographic data compiler 170 draws from a geographic data source 180 and distributes that data among compiled geographic data stores 160 to maximize scalability according to predicted usage patterns.

POI tag data 181 comes from map application 131 users 110, 111 who mark POIs with their own tags. For example, the original geographic data source may mark a POI only as a restaurant. Users may mark that POI as a “Jazz club” or “Piano Bar”. These tags will help users in future discover that specific POI using terms which are very natural for users to try. A POI tag data compiler 171 draws from a POI tag data source 181 and distributes that data among compiled POI tag data stores 161 to maximize scalability according to predicted usage patterns.

Geo-temporal data 182 comes from calendar application 132 users 110, 111 who create calendars and events for POIs and addresses. The geo-temporal data for POIs and addresses are persisted in the geo-temporal data-store. A Geo-temporal data compiler 172 draws from the geo-temporal data store 182 and distributes that data among compiled geo-temporal data stores 162 to maximize scalability according to predicted usage patterns.

Calendar application 132 users 110, 111 also create personal calendars and events, but these may be stored elsewhere and are not considered in further in the description herein.

Compiled Geo-temporal data 162 also comes from general web content. This is gathered via a geo-temporal content compiler 173 which scans incoming web content 143, 183 for geo-temporal data adding it to the compiled geo-temporal data stores 162 to maximize scalability according to predicted usage patterns. For example, a news story written in Seattle on Jun. 15, 2007 about a store robbery in Seattle which took place on Jun. 13, 2007 would yield an event entry in Seattle automatically tagged with “robbery” or some such key words from the article. In this way, various embodiments have the capacity to become an historical record suitable for research.

Tag data is continually being supplied by users. POIs and events do change character over time. As such, it may be important that tag data be weighted to favor recent tags over older tags. Similarly, ratings are continually being supplied by users. POIs and events do change in quality over time. As such, it may be important that ratings be weighed to favor recent ratings over older ratings.

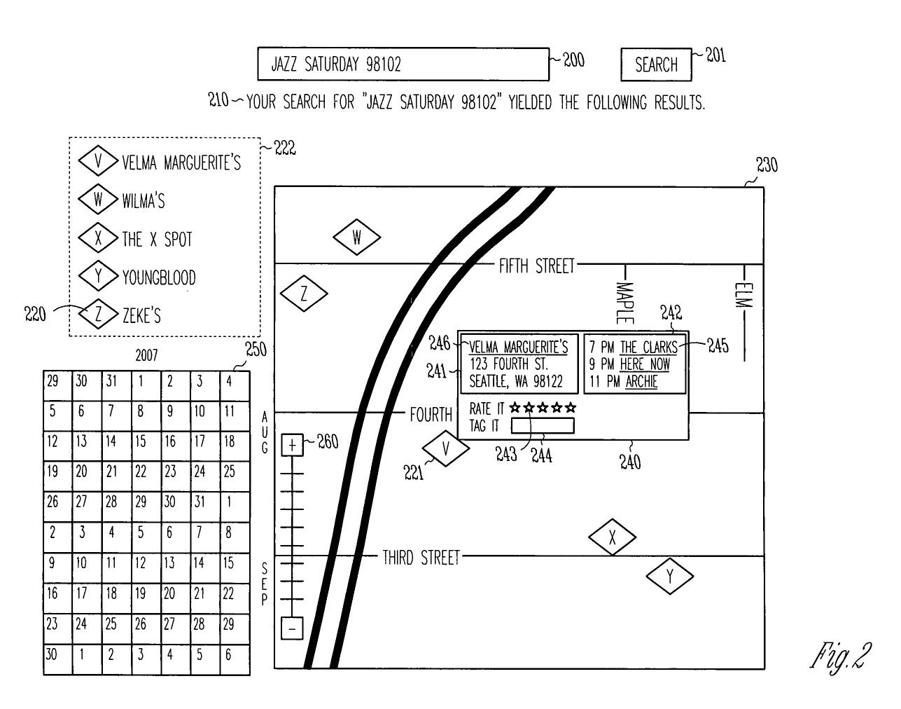

FIG. 2 illustrates an embodiment of the User Interface for discovering events and rating and tagging the POIs which host the events. Much like any modern search engine, the search query is a single data entry form element 200 with an optional “search” button 201. The original query 210 is displayed along with the search results in both serial format 222 and on a map 230. Matches in the serial format have labeled markers 220 corresponding to those 221 on the map 230. A mini-detail pop-up 240 is available to the user via some user event or gesture (e.g. hovering over the map tag 221). This abbreviated detail pop-up might contain digest information about the POI 241, abbreviated detail about the POI's calendar for the time frame of interest 242, the POI's current rating 243 along with a means for the user to rate the POI, a means 244 for the user to tag the POI, a link 246 to the POI's calendar and links to events 245 on the abbreviated calendar detail 242. A mini-calendar 250 may be employed to help the user see and manipulate the time bounds on the search. The zoom tool 260 is a tool for narrowing or broadening the map's 230 scale.

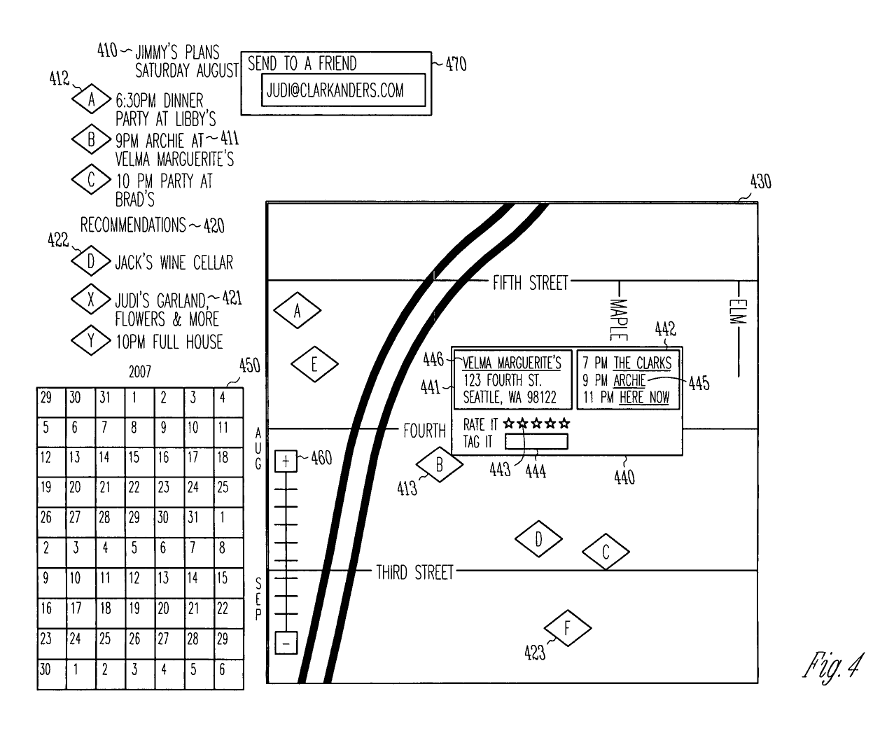

FIG. 18 illustrates one possible embodiment of a mini calendar. The mini-calendar 1800 displays temporal context of the current geo-temporal view (either a search results view as in FIG. 2 or a geo-calendar view as in FIG. 4). It displays the current year 1801, a multi-week or even multi-month view of days 1800, the current day 1802 and the names of the displayed months 1803. The mini-calendar 1804 can be used to select days to be used in the query. In 1805, the user has selected the Fridays and Saturdays of August 17, 18, 24, 25, 31 and of September 1, 7 and 8. In mini-calendar 1806, the user has scrolled down into the future by three weeks in time, but has not changed the days selected for the search itself.

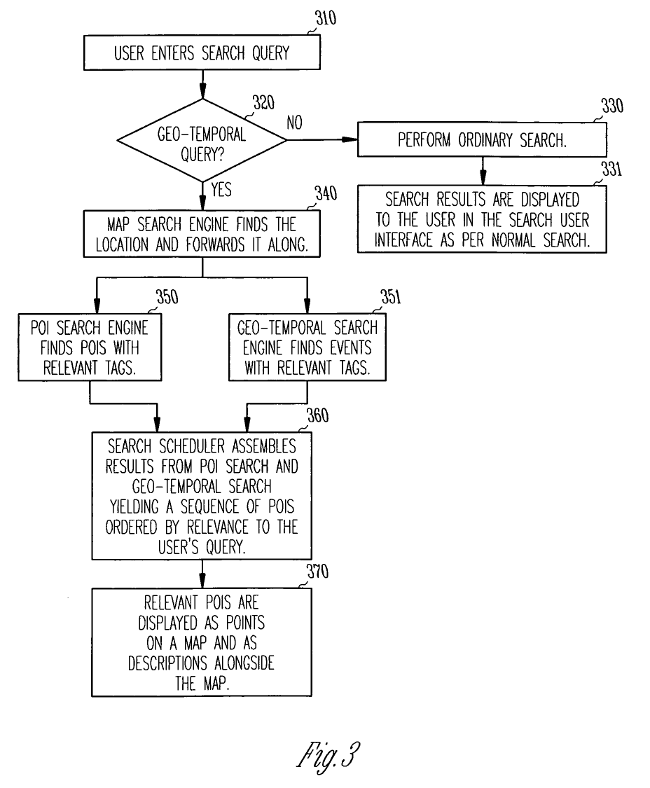

Referring to FIG. 3, in a first step 310, the user enters a search query into the search application 130 or possibly directly into the map application 131. Both of these applications forward the request to the search scheduler 140 shown in FIG. 1. In the second step 320, the search scheduler 140 determines if the query contains geo-temporal information. If not, an ordinary search is performed as in step 330 and displays the results 331 as per the ordinary operation of the search application 130 and presents the results to the user using the ordinary search application's user interface.

If, however, the scheduler 140 detects geo-temporal cues in the query, the scheduler will devise a search plan which incorporates the map search service 150, the POI search relevance service 151, and the geo-temporal search service 152. This plan is highlighted in FIG. 1 in bold, green arrows indicating the flow of data among the services and ultimately back to the map application 131. Following the plan at step 320, control is first passed from the search scheduler 140 to the map search service 150. Here at step 340, the map search service 150 determines exactly where, geographically, the user's query indicates. The map search service 150 passes these intermediate results along with the original query to the next stage of the plan which consists of two searches operating in parallel.

One search is performed by the POI search relevance service 151 at step 350. It uses the original query string to match against names or tags associated with POIs in the geographic region determined by the map search service 150 in step 340. Search results are ordered by relevance to the original query string although paid advertisements for POIs may get special consideration in this ordering. This result, along with the original query string and the intermediate results returned by the map search service 150 are made available to the map application 131.

In parallel, another search is performed by the geo-temporal search service 152 at step 351. It uses the original query string to match against names or tags associated with events in the region determined by the map search service 150. Search results are ordered by relevance to the original query string although paid advertisements for events may get special treatment. This result, along with the original query string and the intermediate results returned by the map search service 150 are made available to the map application 131.

In step 360, the map application 131 reconciles the results from steps 350 and 351. Many reconciliation algorithms are possible and they may be composed of numerous factors. Any mention of algorithms or factors in such algorithms does not limit the various embodiments to that specific algorithm or factor. One such factor might be to prefer event search results whose associated POIs appear in the in the POI search results. Another such factor might be to prefer events similar to events already found in the user's calendar. Another such factor may be to prefer events or POIs with advertisements associated with them. Another such factor may be to prefer POIs the user has frequented before, or whose associates have frequented before. Another such factor may be to prefer POIs or events highly rated by users. Many other factors may come into play in an algorithm to sort the results. In a particular embodiment, these factors may be configurable as options selectable by a user or system administrator.

In step 370, the map application 131 displays the reconciled results to the user 110, 111 as points on a map 230 with references 222 alongside ordered by relevance to the user's query as calculated in step 360.

FIG. 4 illustrates a user's map view of his/her own calendar. This particular view is for a single day, but weekend, work-week, week, month or other views may be useful, too. The components of the calendar include the scheduled events for the time period 410, recommended POIs and events 420, and the map 430 displaying the locations of these events and recommendations. Each scheduled event 411 has a marker 412 which visually associates it with a corresponding marker 413 on the map 430. Similarly, each recommended POI or event 421 has a marker 422 which visually associates it with a corresponding marker 423 on the map 430. The user can get digest information about the POI by hovering over the marker 413. This causes a pop-up 440 to display containing digest information about the POI or event. As illustrated in FIG. 4, one set of digest information could be POI name and location 441, mini-calendar for the related timeframe 442, customer rating 443, tagging entry box 444 and links to see the calendars for the POIs 446 and links to see the calendars for the mini-calendar 442 events 445 in the pop-up 440. This is only an example. Other blending of information and capabilities in the digest pop-up 440 are certainly possible within the scope of the various embodiments.

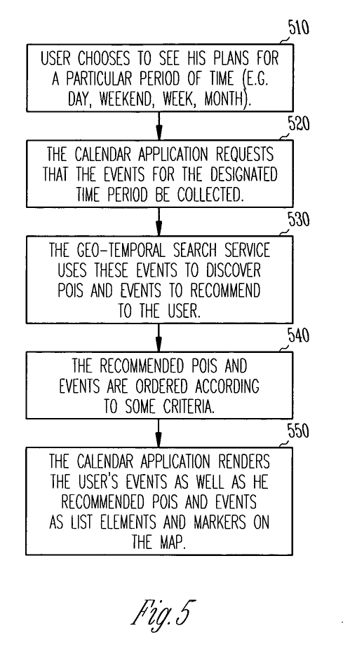

The recommendations 420 in FIG. 4 are POIs and events which may interest the user. The recommendations 420 are calculated according to the scheme laid out in FIG. 5. In step 510, the user chooses to see his/her plans for a particular time period (e.g. a day, month, weekend, work week, week, month, etc.). In step 520, the calendar application collects the events for the designated time period. In step 530, the calendar application draws hints from a number of data sources to determine the kind of events or POIs may be of interest to the user. Once these hints are obtained, they can be used as search terms to find matching POIs and events in an automated fashion analogous to the manual approach illustrated in FIGS. 2 and 3. The mini calendar 450 and zoom tool 460 help the calendar owner move through time and space. The calendar owner can also share events with friends 470 by, perhaps, supplying the friend's email address, phone number or simply by selecting the friend from a contacts list. Other means of identifying the friend are possible and the various embodiments are not limited to the means listed above.

The data sources where the hints are found may include but are not limited to the user's scheduled events for the aforementioned time period, other events in the user's calendar, other events not associated with the user for that time period or location or nearby time periods and locations paid or unpaid by advertising funds, searches the user has performed in the past in the map application 131 or in the search application 130, emails, text messages, attachments, purchases, or other transmissions or documents otherwise associated with the user, the user's associates, other users with profiles similar to the user by some standard, popular or highly rated events or POIs at or around that time and place, etc. In step 540, the recommended POIs and events are rated for relevance, financial yield (in the case of paid advertisements), etc. and sorted according to the rating. Only the top few rated recommendations are displayed in step 550 as shown in FIG. 4.

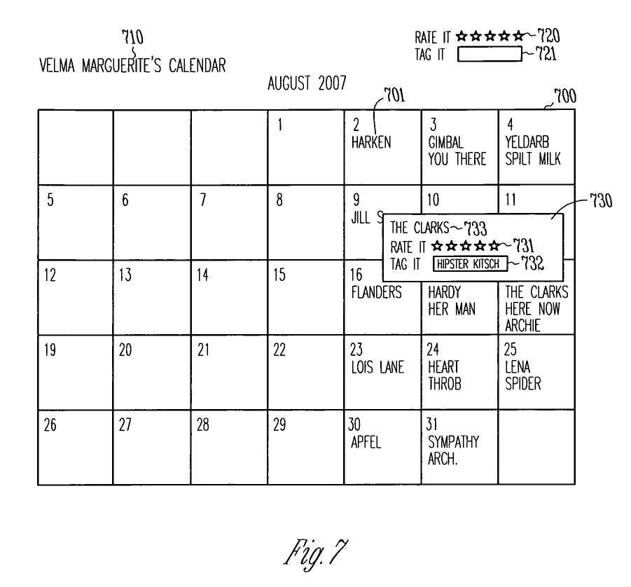

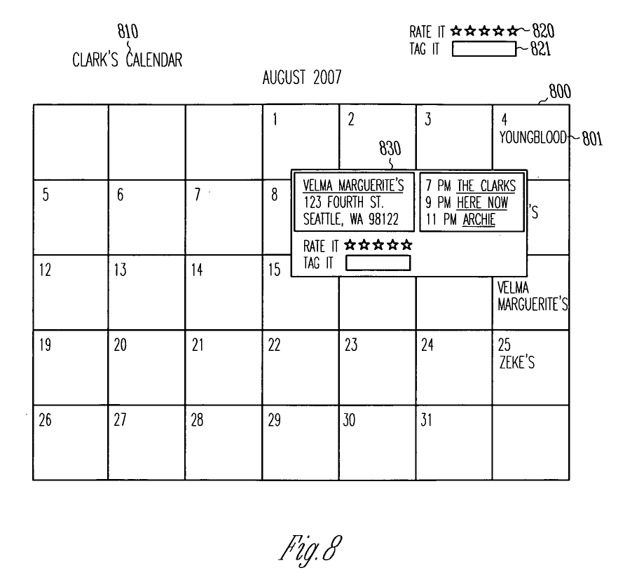

Advertising for POIs and events can surface in any number of places including but not limited to geo-temporal search results 222, geo-calendar recommendations 420, a POI's calendar view (see FIG. 7), or the calendar for the current user or of another user (see FIG. 8). The advertiser can buy search terms limited by geographic location or by geographic location combined with time bounds. Buying search terms is common practice today, however it has never been combined with specific geo-temporal regions, nor have search terms been implied (see Hint Sources described herein). This geo-temporal extension is novel; it allows offline, physical businesses to benefit from online advertising; it will draw customers to their POIs and events. This, in effect, extends internet advertising to the physical world. The advertiser can buy a ‘quick-ad’ for his/her POI or his/her event. A ‘quick-ad’ takes a snapshot of a POI's (or event's) tags and promotes the POI (or event) based on the tags in the snapshot. One reason to advertise against a snapshot of the tags rather than advertising against the dynamic set of tags for that POI (or event) is to prevent an advertiser from buying the ad, then later adding tags to his/her POI (or event) to increase the reach of his/her advertisement. One reason to advertise against tags rather than against specific terms is that users tag POIs and events. As such, the tags are more likely to produce advertisement hits than are the search terms explicitly selected by a human advertiser.

The advertiser can buy ads intended to complement the user's calendar or the user's search terms. For example, if the customer's calendar shows him/her going to a restaurant at 7 pm, a nearby dessert shop would benefit by being displayed. While the dessert shop could also benefit by buying the term “dessert” or the term “dinner” or “restaurant”, those terms will be in high demand. It will likely be less expensive to buy the “complementary ad” to the term “restaurant”. True, the advertisement may only display in the customer's recommendations on his/her geo-calendar view (see FIG. 4), but this may be cheaper than buying “restaurant” as a first-class search term.

Some semantic hints may become part of the system itself. For instance, the system may recognize that the user's scheduled events indicate the user is traveling. Advertisers could make their advertisements conditional on such triggers. For instance, a local hotel may choose to advertise without any tag reference if the “travel” trigger is set. The examples above are only meant to illustrate the various embodiments, not to limit them.

As noted above, the hints to use or direct advertising may come directly from a user's 110, 111 search terms 200, or they may come from more subtle sources. These hint sources are described in more detail herein.

Payment for the advertisement may be trigged when the user “clicks through” to see more information about the POI or the event according to a Uniform Resource Locator (URL) associated with the POI or event. Payment for the advertisement may be triggered when the user chooses to see the POI's calendar (or event's calendar). Payment may be triggered when the user adds the event to his/her calendar or adds the POI to his/her calendar associating it with a new or existing event. Payment for the advertisement may be triggered upon display of the advertisement. Payment for the advertisement may be triggered when the user gets more information about the POI or event using the mini-detail 240, 440, 650 feature. Payment for the advertisement may be triggered by some other event not listed above. Payment for the advertisement may be triggered by any combination of the above events listed (or not listed) above.

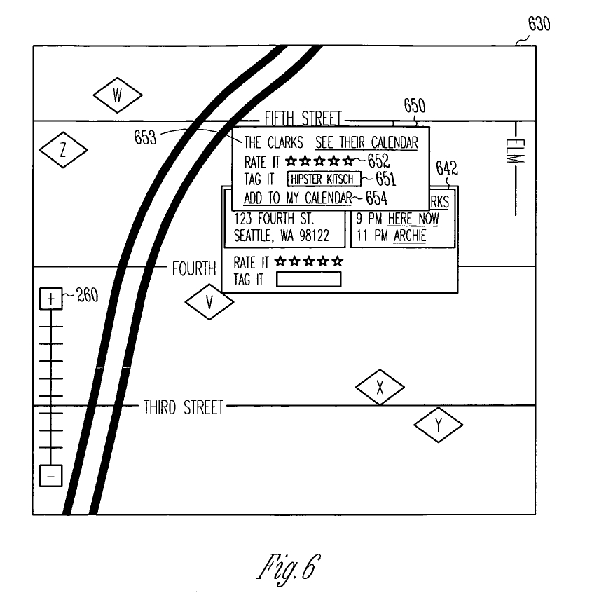

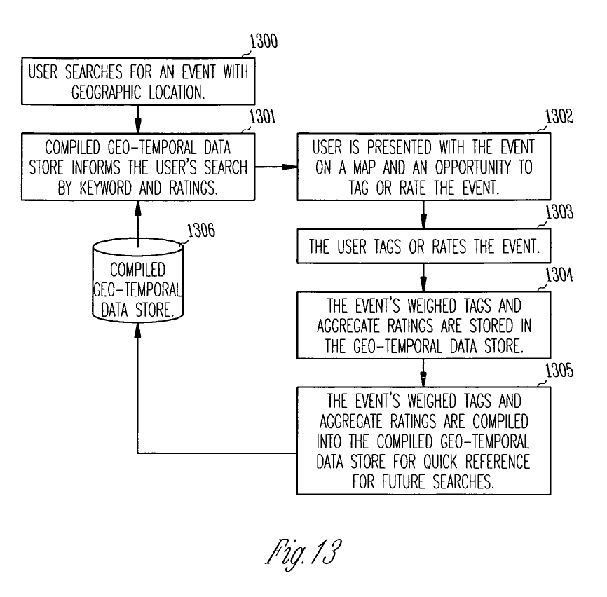

FIG. 6 illustrates a view similar to FIG. 2, but with a pop-over abbreviated detail 650 for a specific event on the POI's mini-calendar 642. This pop-over allows the user to see some details for that event including but not limited to the event's rating 652. It also allows the user to perform actions on the event including but not limited to viewing the calendar of a primary participant in the event 653, rate the event 652, tag the event 651 or add the event to the user's calendar 654. Rating or tagging an event feeds the rating or tag data back into the POI tag data store 181 as described in FIG. 13.

FIG. 7 illustrates a POI calendar. Users can add events to a POI's calendar. By default, a POI's calendar is open to the public who can add, delete and edit events at will. It is possible for users to claim ownership of a POI, restricting access to the POI's calendar. In FIG. 7, the POI calendar view is titled with the name of the POI 710. The POI calendar view presents a calendar 700 at some granularity over some time period, displays events 701 in the calendar 700, displays the current user-rating of the POI 720 and allows the current user to submit his/her own rating 720, allows the current user to tag the POI 721 and allows the user to quickly view some details about an event 730 including allowing the user to rate the event 731, tag the event 732 or view the calendar of the primary user in the event 733.

FIG. 8 illustrates a user calendar. While the illustration appears to be a web page, particular embodiments can be for mobile phones, mobile computing devices, in-car devices or other devices. This illustration does not limit the scope of the various embodiments to the particular described example. A user calendar is owned by the user and, by default, other users are unable to view the calendar or add, edit or remove events from the calendar. However, the user can grant access to other users. In FIG. 8, the user calendar view is titled with the owner's name 810, presents a calendar 800, displays the aggregate user rating of the owner 820, and allows the current user to submit his/her own rating of the owner 821 and allows the user to quickly view some of the details about an event 830. For most users, user-ratings 820 will not be appropriate, so the user is free to enable or disable this feature on their calendar. Similarly, tags 821 can be enabled or disabled by the calendar owner.

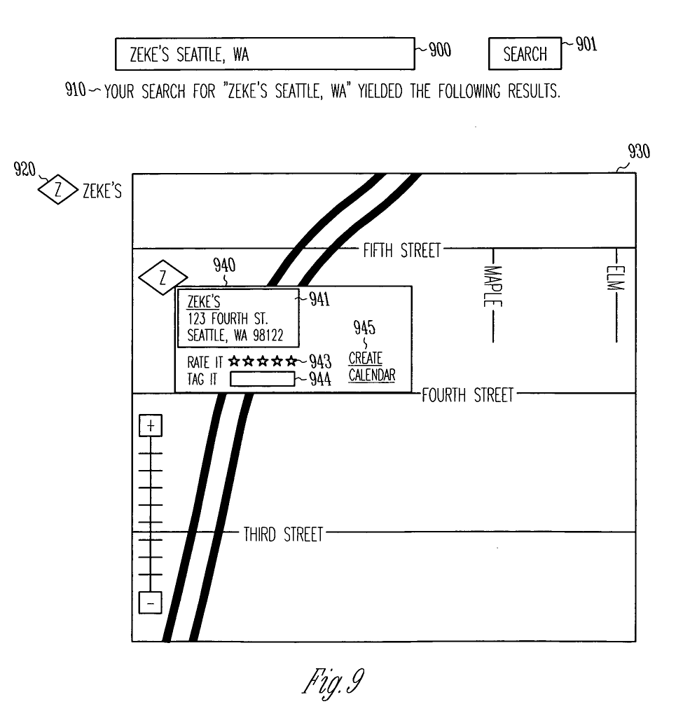

FIG. 9 illustrates searching for a POI which has no calendar associated with it. The user 110, 111 enters search criteria 900. The search results are displayed as described elsewhere in this document with one exception—because the resulting POI 920 has no associated calendar, its mini-details pop-over 940 does not contain a digest calendar 241. Instead, it does offer the user the opportunity to create a calendar 945. As in the mini-details pop-over for a POI with a calendar 240, a mini-details pop-over for a POI without a calendar includes the POI's current rating along with a means for the user to rate it 943 and a means for the user to tag the POI 944.

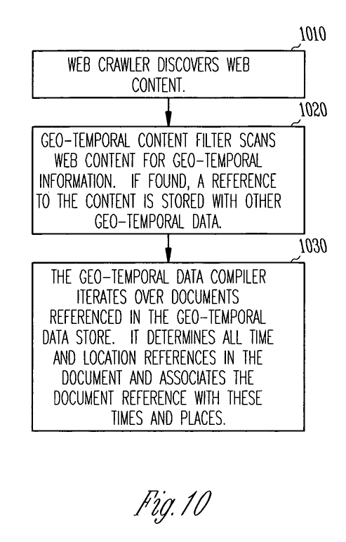

FIG. 10 illustrates the automatic processing of internet content to incorporate that content into geo-temporal data stores. In step 1010, a web crawler discovers web content. Likely, the content is stored locally, at least temporarily, in order to process it for a variety of purposes. One purpose is to glean geo-temporal data from the document as in step 1020. If the document is found to have geo-temporal content, an event is created and a reference to the document is persisted along with that event. The event is persisted with geo-temporal data 182. It is possible that this data can be categorized in ways illustrated by, but not limited to, news events, census events, economic events, weather events, crime events, real estate events, business events, advertising events, etc.

For example, a news article in the New York Times written in New York on Feb. 2, 2000 about the New Hampshire primary might yield two events both on Feb. 2, 2000. One event in New Hampshire and another in New York, N.Y. Note the scale difference in these two events. The first is at the state scale while the other is at the city level. The most important of these two events is the one in New Hampshire, of course. Because the article was written in NYC and is tagged as such in the article itself, it is possible to automatically account for the distinction between the event and the writing about the event.

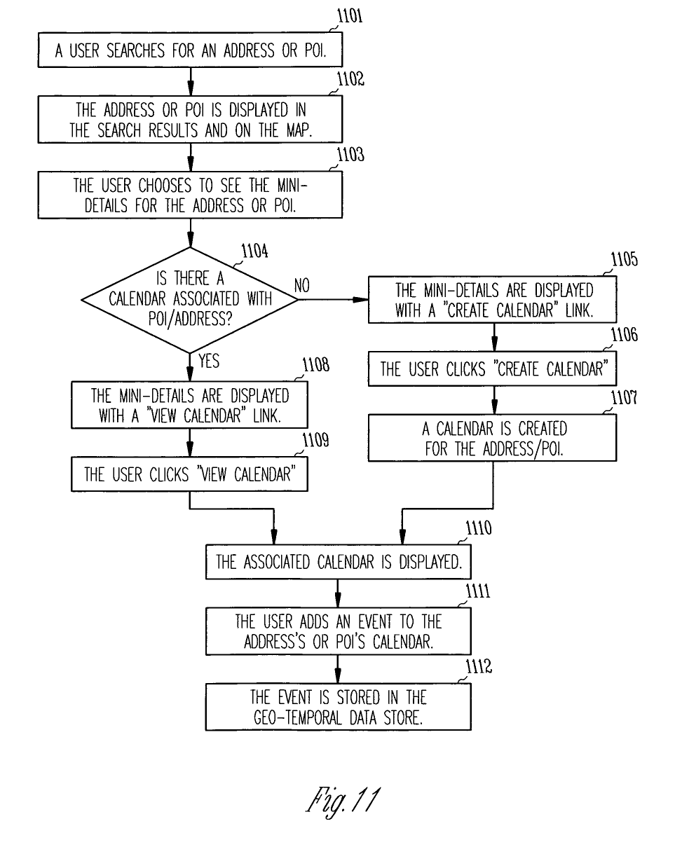

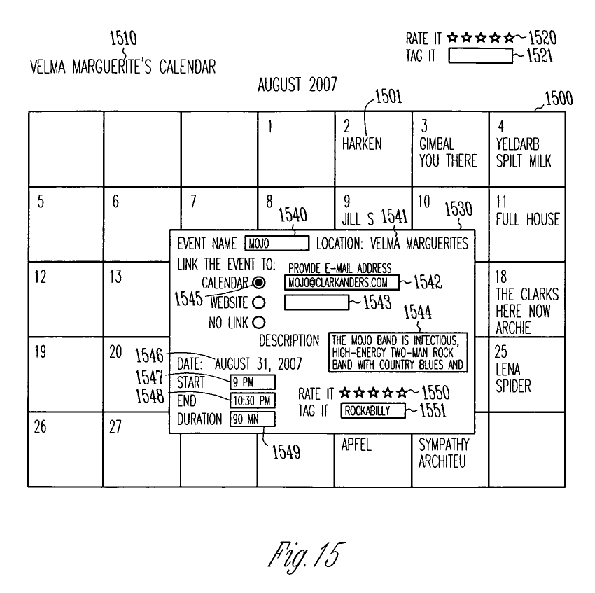

FIG. 11 illustrates how a user adds an event to a POI or an address. In step 1101, the user 110, 111 searches for an address or POI using either the search application 130 or the map application 131. In step 1102, the search results are displayed in the map application 131 with markers on the map 221. In step 1103, the user chooses to see the mini-details 240 for the address or POI. Step 1104 is a decision point for rendering the address's or POI's mini-details. If the address or POI does not yet have an associated calendar, the mini-details 940 are rendered with an option for the user to create a calendar 945 and associate it with the address or POI as in step 1105. In step 1106, the user chooses to create a new calendar. As a result, a calendar is created for the address or POI as in step 1107. If the user does not actually add an event to this calendar, then the calendar is destroyed without ever being associated with the address or POI. If, however, the address or POI does have an associated calendar, the mini-details 240 are rendered 1108 with an option 246, 446 for the user to view the calendar 700 associated with the address or POI. In step 1109, the user chooses to view the address's or POI's calendar 700. Either way 1104, the calendar associated with the address or POI is rendered in step 1110. At step 1111, the user adds an event to the address's or POI's calendar in much the same way s/he would add an event to his/her own calendar as illustrated in FIG. 15. In step 1112, the event is stored in the geo-temporal data store 182 associated with the address or POI.

FIG. 15 illustrates one embodiment for creating a new event from within a POI's calendar 1500. This embodiment is simply an example and does not limit the scope of the described embodiments. Other embodiments are possible. The calendar has a label 1510, offers the user the ability to rate 1520 or tag 1521 the POI. The calendar also features events 1501. Various means are provided to create a new event. 1530 is an example of such a means, perhaps activated by clicking on a calendar day in an area without an event. In this example, there are two fixed pieces of information: the location 1541 and the date 1546. Other embodiments may not require these be fixed. The example 1530 allows the user to name the event 1540, link the event to a calendar by some means 1542, 1545, link the event to a URL 1543, describe the event 1544, note the timeframe for the event 1547, 1548, 1549, rate the event 1550 and tag the event 1551.

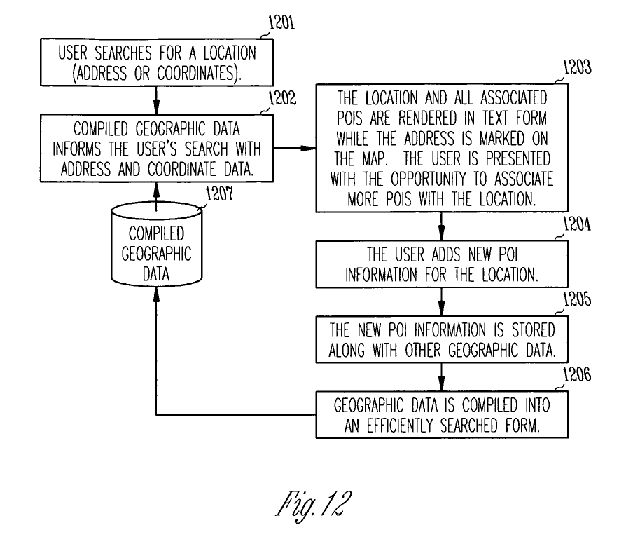

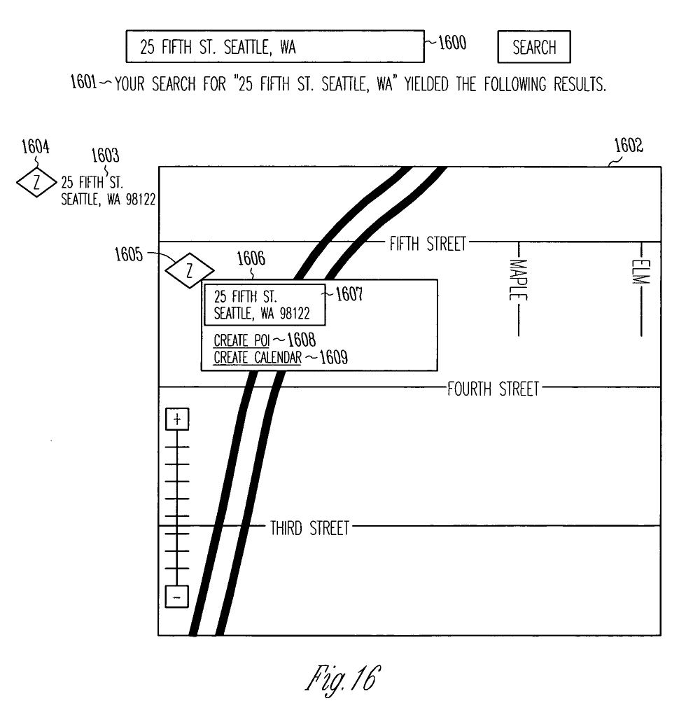

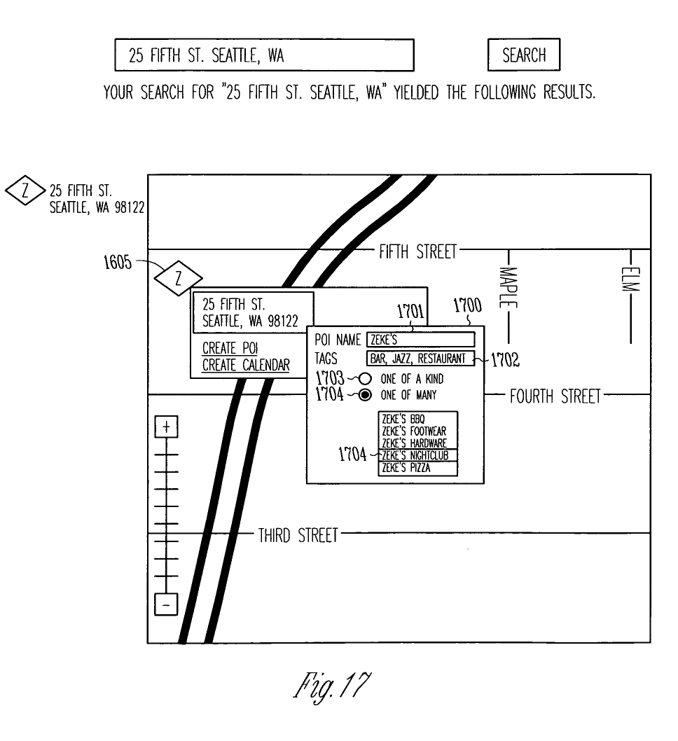

FIG. 12 illustrates an example process for creating a new POI for a given location. In step 1201, the search application 130 user 110, 111 or map application 131 user 110, 111 searches for a location. A location may be specified by an address (e.g. 1410 30th Ave, Seattle, Wash. 98122), by partial address (e.g. Seattle, Wash.), by coordinates (47.63 N, 122.33 W), by current position (e.g. fed by GPS or other means) or by any other means. In step 1202, the map search service 150 finds the location and its associated POIs using data found in the compiled geographic data store 160, 1207. In step 1203, the map application renders the location and associated POIs along with a means for the user to associate a new POI with the location. In step 1204, the user associates a new POI with the location. One possible embodiment of this interface is illustrated in FIGS. 16 and 17. Here, the familiar map application 131 is shown with the search results 1601, 1602 for the user's query 1600: “25 Fifth St. Seattle, Wash.”. Text results 1603 and their marker 1604 are displayed along with their geographical representation 1605 on the map 1602. The user can uncover a mini-details page 1606 for the POI by some means. The mini-details page might include something like the location description 1607 and a means for creating a new POI 1608 and a means for creating a calendar 1609 even if no POI is created. The customer who indicates his/her desire to create a POI is given the means to do so 1700. S/he would supply information about the POI. Such information may include, but is not limited to the POI name 1701, initial tags 1702, whether the POI was a unique instance 1703 or whether it is one of many related POIs 1704. In step 1205, the new POI information is stored in the geographic data store 180 and the POI tag data store 181. In step 1206, the geographic data compiler 170 compiles the new data and stores it in the compiled geographic data store 160, 1207. Also in step 1206, the POI tag data compiler 171 compiles the new data and stores it in the compiled POI tag data store 161.

FIG. 13 illustrates tagging or rating an event. In step 1300, the search application 130 user 110, 111 or the map application 131 user 110, 111 searches for an event with a geographic location. This is illustrated in 200 where the user searches for “jazz saturday 98102”. In step 1301, the map search service 150, the POI search relevance service 151 and the geo-temporal search service 152 cooperate under the direction of the search scheduler 140 to yield relevant POIs and events in the map application 131. Of particular interest in step 1301 is the input from the compiled geo-temporal data store 162, 1306. These results from step 1301 are displayed in step 1302 along with a means for tagging 651 or rating 652 the event. In step 1303, the user tags or rates the event which triggers step 1304 where the tag and/or rating is stored in the geo-temporal data store 182. In step 1305, the geo-temporal data compiler 172 compiles the tag and/or rating into the compiled POI tag data store 162, 1306.

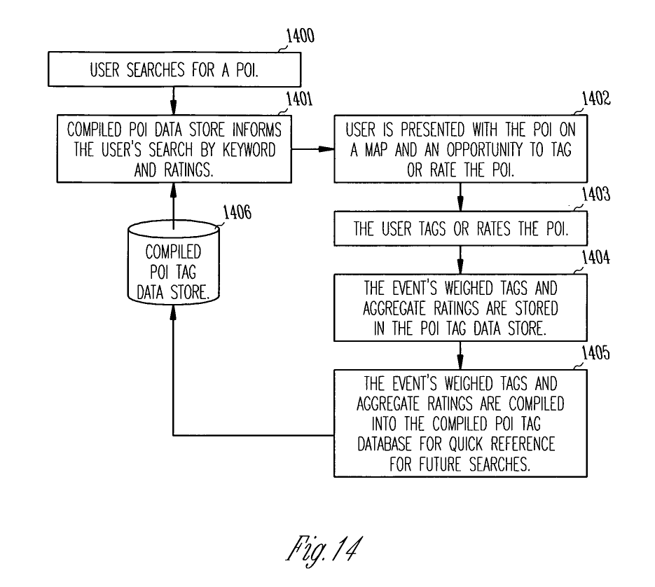

FIG. 14 illustrates tagging or rating a POI. In step 1400, the search application 130 user 110, 111 or the map application 131 user 110, 111 searches for a POI. This is illustrated in 900 where the user searches for “Zeke's Seattle, Wash.”. The map search service 150, the POI search relevance service 151 and the geo-temporal search service 152 cooperate under the direction of the search scheduler 140 to yield relevant POIs in the map application 131. Of particular interest in step 1401 is the input from the compiled POI tag data store 161, 1406. These results from step 1401 are displayed in step 1402 along with an opportunity to tag or rate the POI. In step 1403, the user tags 244 or rates 243 the POI. FIG. 2 is only one example embodiment of such a user interface (UI) and does not limit the scope of the described embodiments. As a result of step 1403, the new tags and/or ratings are stored in the POI tag data store 181 in step 1404. In step 1405, the POI tag data compiler 171 compiles the new data and stores it in the compiled POI data store 161, 1406.

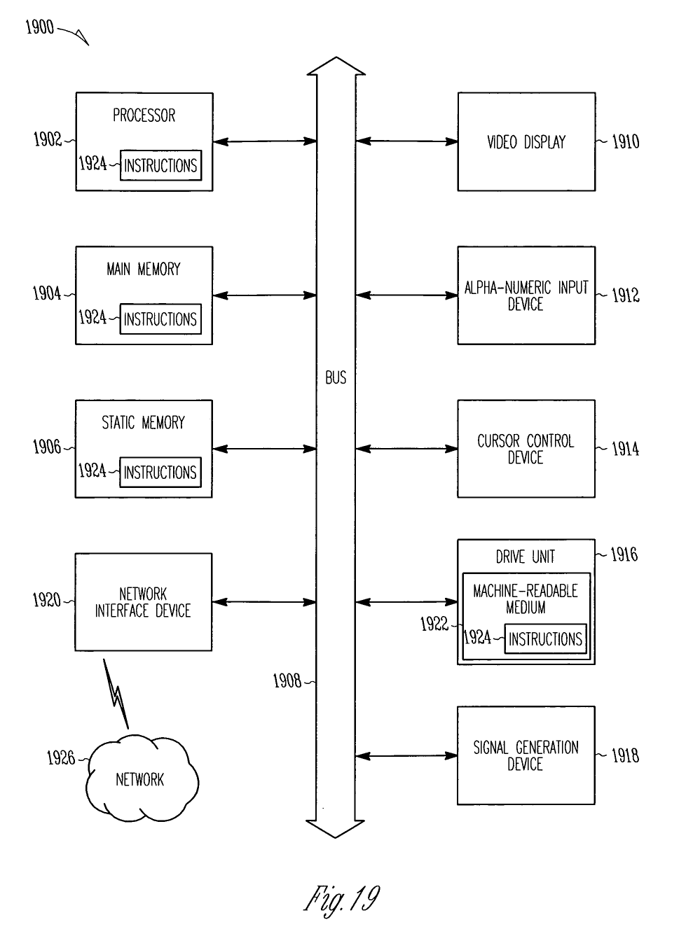

FIG. 19 shows a diagrammatic representation of a machine in the example form of a computer system 1900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU), or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an input device 1912 (e.g., a keyboard), a cursor control device 1914 (e.g., a mouse), a disk drive unit 1916, a signal generation device 1918 (e.g., a speaker) and a network interface device 1920.

The disk drive unit 1916 includes a machine-readable medium 1922 on which is stored one or more sets of instructions (e.g., software 1924) embodying any one or more of the methodologies or functions described herein. The instructions 1924 may also reside, completely or at least partially, within the main memory 1904, the static memory 1906, and/or within the processor 1902 during execution thereof by the computer system 1900. The main memory 1904 and the processor 1902 also may constitute machine-readable media. The instructions 1924 may further be transmitted or received over a network 1926 via the network interface device 1920.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 1922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented system and method for enabling users to associate temporal data with geographic locations or POIs are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

1. A computer-implemented method comprising:
associating geographical locations or points of interest with events having geographical and temporal attributes in a geo-temporal data store;
receiving a geo-temporal search query specified by a user; and
producing search results including paid advertisements such that the presence of the paid advertisements is dependent upon the relevance of the paid advertisements to either the geographic attributes of the geo-temporal search query, the temporal attributes of the geo-temporal search query, data associated with the user, data associated with a user's known associates, search terms provided by the user, or a combination thereof.

2. The method of claim 1, including determining which paid advertisements to display.

3. The method of 1, including detecting features of a user's calendar and offering the user features as triggers for advertisers.

4. The method of 1, including displaying advertisements selected for particular points of interest or locations.

5. The method of 1, including providing an interface enabling a user to buy an advertisement for a point of interest or location.

6. The method of 1, including determining when a user's point of interest advertisement is deemed to be chargeable.

7. The method of 1, including displaying advertisements selected for particular events.

8. The method of 1, including providing an interface enabling a user to buy an advertisement for an event.

9. The method of 1, including determining when a user's event advertisement is deemed to be chargeable.

10. A computer-implemented method comprising:
associating geographical locations or points of interest with events having geographical and temporal attributes in a geo-temporal data store;
receiving a geo-temporal search query specified by a user; and
producing search results including items from the geo-temporal data store having a pre-determined degree of relevance to the geo-temporal search query in both a geographical and temporal domain possibly combined with their relevance to data associated with the user, data associated with a user's known associates, search terms provided by the user, or a combination thereof.

11. The method of claim 10 including storing points of interest and events in databases suitable for users to create, read, update or delete.

12. The method of claim 10 including storing tags and ratings for points of interest and events in databases suitable for users to create, read, update or delete.

13. The method of claim 10 including scheduling execution of a search among search services including search services responsible for geo-temporal data.

14. The method of claim 10 including determining an order in which to display the search results to the user such that the order is dependent upon the relevance to both the geographic elements of the query and the temporal elements of the query.

15. The method of claim 10 including compiling points of interest, tags, ratings and events into forms suitable for global-scale search based on expected usage patterns.

16. The method of claim 10, including providing an interface enabling a user to create a point of interest to associate with a geographic location.

17. The method of claim 10, including providing an interface enabling a user to associate a plurality of points of interest with a given location.

18. The method of 10, including providing an interface enabling a user to create an event for a point of interest or location.

19. The method of claim 10, including presenting an interface for manipulating a time element of the geo-temporal search.

20. The method of claim 10, including tagging a point of interest or an event.

21. The method of claim 10, including rating a point of interest or an event.

22. The method of 10 wherein user supplied tags are stored to favor recent tags over historic tags.

23. The method of 10 wherein user supplied ratings are stored to favor recent ratings over historic ratings.

24. The method of claim 10 wherein an event associated with a point of interest may have a primary user associated with the event.

25. The method of claim 10, wherein the point of interest is displayed in text form with a marker next to it relating it to its representation in the map.

26. The method of claim 10, wherein the point of interest is represented on the map as a marker relating it to the text form with a similar marker.

27. The method of claim 10, wherein producing search results includes displaying a point of interest having attributes associated with the point of interest.

28. The method of claim 11, including providing an interface enabling a user to rate the point of interest or event.

29. The method of claim 11, including providing an interface enabling a user to tag the point of interest.

30. A computer-implemented method comprising:
providing open access for users to create an event related to a geographical location or a point of interest, the event having geographical and temporal attributes, the geographical location or point of interest having ownership attributes;
storing information related to the event and the geographical location or point of interest in a geo-temporal data store; and
authorizing access to the information by other users.

31. The method of 30, wherein a user may claim ownership of a point of interest.

32. The method of 30, wherein a user can cede ownership of a point of interest to another user.

33. The method of 30, wherein users can dispute the ownership of a point of interest.

34. The method of 30, wherein a user can wrest ownership of a point of interest from another user.

35. The method of 30, wherein a user can cede ownership of a point of interest to the public at large.

36. A computer-implemented method comprising:
providing an electronic calendar, the calendar including events and points of interest, each having geographical and temporal attributes;
providing a text view of the calendar;
providing a geographic view of the calendar;
displaying details for the points of interest and the events; and
enabling a user to add a geo-temporal event to the calendar.

37. The method of claim 36, including providing an interface enabling the user to tag events in the calendar.

38. The method of claim 36, including providing an interface enabling the user to rate events in the calendar.

39. The method of claim 36, including providing an interface enabling a user to share a geo-temporal event from the calendar with another person or entity.

40. The method of 36, including displaying a calendar associated with a point of interest.

41. The method of 36, wherein an owner of a point of interest may grant authorization to read and manipulate a calendar associated with a point of interest to other users.

42. The method of claim 36, including enabling the user to create a calendar associated with a point of interest.

43. The method of claim 36, including displaying a geo-calendar view to a user, the geo-calendar view including a map.

44. The method of 43, including displaying events for a given time frame in text form with a marker at a corresponding location on the map.

45. The method of 43, including displaying relevant points of interest or locations graphically on the map as the relevant points of interest or locations relate to events on the user's calendar.

46. The method of 45, including providing an interface enabling a user to rate the points of interest or locations.

47. The method of 45, including providing an interface enabling a user to tag the points of interest or locations.

48. The method of claim 45, including displaying a mini-calendar of events for the points of interest for a given time.

49. The method of claim 36, including displaying details of events in a mini-calendar.

50. The method of claim 49, including providing an interface enabling a user to tag an event in a details display.

51. The method of claim 49, including providing an interface enabling a user to rate an event in a details display.

52. The method of claim 49, wherein the user can see a calendar of a primary user associated with an event in a details display.

53. The method of claim 36, including rendering search results in a geographic form; enabling the user to modify a geo-temporal search query by manipulating geo-temporal parameters; and linking the search results to calendars associated with points of interest and events.

54. The method of claim 1 wherein the geo-temporal search query specified by the user is received from the user's mobile device.

55. The method of claim 4 wherein the advertisements are displayed on the user's mobile device.

56. The method of claim 5 wherein the interface is implemented on the user's mobile device.

57. The method of claim 7 wherein the advertisements are displayed on the user's mobile device.

58. The method of claim 8 wherein the interface is implemented on the user's mobile device.

59. The computer-implemented method of claim 10 wherein the geo-temporal search query specified by the user is received from the user's mobile device.

60. The computer-implemented method of claim 14 wherein the search results are displayed on the user's mobile device.

61. The computer-implemented method of claim 16 wherein the interface is implemented on the user's mobile device.

62. The computer-implemented method of claim 17 wherein the interface is implemented on the user's mobile device.

63. The computer-implemented method of claim 18 wherein the interface is implemented on the user's mobile device.

64. The computer-implemented method of claim 19 wherein the interface is implemented on the user's mobile device.

65. The computer-implemented method of claim 25 wherein the point of interest is displayed on the user's mobile device.

66. The computer-implemented method of claim 26 wherein the point of interest is displayed on the user's mobile device.

67. The computer-implemented method of claim 27 wherein the point of interest is displayed on the user's mobile device.

68. The computer-implemented method of claim 28 wherein the interface is implemented on the user's mobile device.

69. The computer-implemented method of claim 29 wherein the interface is implemented on the user's mobile device.

70. The computer-implemented method of claim 30 wherein the event related to a geographical location or a point of interest is created on the user's mobile device.

71. The computer-implemented method of claim 36 wherein the method is implemented on the user's mobile device.

72. The computer-implemented method of claim 37 wherein the interface is implemented on the user's mobile device.

73. The computer-implemented method of claim 38 wherein the interface is implemented on the user's mobile device.

74. The computer-implemented method of claim 39 wherein the interface is implemented on the user's mobile device.

75. The computer-implemented method of claim 40 wherein the calendar is displayed on the user's mobile device.

76. The computer-implemented method of claim 43 wherein the geo-calendar view is displayed on the user's mobile device.

77. The computer-implemented method of claim 44 wherein the events are displayed on the user's mobile device.

78. The computer-implemented method of claim 45 wherein the relevant points of interest or locations are displayed on the user's mobile device.

79. The computer-implemented method of claim 46 wherein the interface is implemented on the user's mobile device.

80. The computer-implemented method of claim 47 wherein the interface is implemented on the user's mobile device.

81. The computer-implemented method of claim 48 wherein the mini-calendar of events is displayed on the user's mobile device.

82. The computer-implemented method of claim 49 wherein the details of events are displayed on the user's mobile device.

83. The computer-implemented method of claim 50 wherein the interface is implemented on the user's mobile device.

84. The computer-implemented method of claim 51 wherein the interface is implemented on the user's mobile device.

85. The computer-implemented method of claim 52 wherein the details display is displayed on the user's mobile device.

86. The computer-implemented method of claim 53 wherein the method is implemented on the user's mobile device.

87. The method of claim 54 wherein the user's mobile device includes geo-location information that is automatically added to the geo-temporal search query.

88. The method of claim 55 wherein the user's mobile device includes geo-location information that is automatically used to select advertisements related to the user's geo-location.

89. The method of claim 59 wherein the user's mobile device includes geo-location information that is automatically added to the geo-temporal search query.

90. The method of claim 70 wherein the user's mobile device includes geo-location information that is automatically used to create the event.

91. The method of claim 77 wherein the user's mobile device includes geo-location information that is automatically used to create the display of the events.

92. The method of claim 78 wherein the user's mobile device includes geo-location information that is automatically used to create the display of the relevant points of interest or locations.

93. The method of claim 81 wherein the user's mobile device includes geo-location information that is automatically used to create the display of the mini-calendar of events.
